(19) United States
(12) Patent Application Publication
(10) Pub. No.: US 2011/0015892 A1
(43) Pub. Date: Jan. 20, 2011

(54) METHOD AND APPARATUS FOR DECIDE TRAVEL CONDITION USING SENSOR

(75) Inventors: Kwon Soo Lee, Gyeonggi-do (KR); Yong Kwan Park, Seoul (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: THINKWARE SYSTEMS CORPORATION, SEOUL (KR)

(21) Appl. No.: 12/599,806

(22) PCT Filed: Jun. 25, 2007
(86) PCT No.: PCT/KR07/03056

§ 371 Date: Nov. 11, 2009

(30) Foreign Application Priority Data
May 11, 2007 (KR) 10-2007-0046083

(51) Int. Cl. G06F 15/00; G01P 15/00; G01P 15/18

(52) U.S. Cl. 702/141

(57) ABSTRACT

A method and apparatus of determining a stationary state and a driving state of a moving object using a sensor are provided. The method of determining a driving state using a sensor includes: calculating an amount of change ΔP in a sensor output signal of the sensor wherein the sensor detects a vibration of a moving object; and comparing the calculated amount of change ΔP in the sensor output signal with a predetermined set range of the sensor output signal and determining whether the moving object is in a stationary state or in a driving state.

### FIELD OF THE DISCLOSURE

The present disclosure relates to a navigation system, and more particularly, to a method and apparatus for determining a driving state and a stationary state of a moving object using a sensor.

### BACKGROUND OF THE DISCLOSURE

Generally, a navigation system is a system which provides information for driving of a transportation device, such as a vehicle, using an artificial satellite. The navigation system is automatic.

A typical navigation system is configured into one terminal and includes a storage medium to store map data. Also, the navigation system includes a Global Positioning System (GPS) receiver to receive GPS signals.

The navigation system calculates a location of a vehicle, informs a user of a current location of the vehicle based on the calculated location of the vehicle. Also, the navigation system routes an optimal path from the current location to the user's desired destination and guides the user to the desired location, providing the user with various types of associated information along the path.

A method of calculating a location of a vehicle receives location data from a GPS satellite using a GPS receiver, and calculates the current location of the vehicle based on the received location data.

Another method of calculating a location of a vehicle calculates the current location of the vehicle using a gyro sensor and an acceleration sensor, which are installed in the vehicle. In this instance, the other method receives GPS signals, calculates the current location of the vehicle based on the received GPS signals, and corrects the calculated current location based on results detected by the gyro sensor and the acceleration sensor.

Also, it is possible to determine a driving state and a stationary state of the vehicle by using the acceleration sensor. For this, the driving state and the stationary state is determined by measuring a value of the acceleration sensor obtained in the stationary state, setting the value to an initial value, and comparing the initial value with a current output value of the acceleration sensor.

One of various methods of setting the initial value may pre-set the initial value in a terminal through a test at the point in time when the terminal is manufactured. Another method may directly perform initialization in the stationary state before the user uses the terminal.

However, in the case of a portable navigation device, a mounting location and an installation method of the portable navigation device in a vehicle are not particularly determined. Specifically, the mounting location and the installation method can change depending on the user's taste and the circumstance in the vehicle. Accordingly, the mounting location in the vehicle should be recommended to be the same as when the initial value is obtained. Also, every time the mounting location or the installation method is changed, a new initial value must be obtained.

Particularly, when a user desires to set an initial value, the initial value should be obtained in the stationary state at all times. Accordingly, the user is requested to directly perform an operation of setting a new initial value in the stationary state.

Also, the initial value may be automatically set by software without manipulation of the user while the vehicle is stopped. In this case, it is not guaranteed that the moment of setting the initial value is the stationary state and thus reliability about the initial value and determination results are decreased.

### SUMMARY OF THE DISCLOSURE

An aspect of the present disclosure provides a method and apparatus of determining a driving state which can more accurately determine a driving state of a moving object without a separate process of setting an initial value when a navigation device is manufactured or released.

An aspect of the present disclosure also provides a method and apparatus of determining a driving state using a sensor which can improve reliability about driving state determination results of a moving object.

According to an aspect of the present disclosure, there is provided a method of determining a driving state using a sensor, the method including: calculating an amount of change ΔP in a sensor output signal of the sensor wherein the sensor detects a vibration of a moving object; and comparing the calculated amount of change ΔP in the sensor output signal with a predetermined set range of the sensor output signal and determining whether the moving object is in a stationary state or in a driving state.

According to another aspect of the present disclosure, there is provided an apparatus for determining a driving state, the apparatus including: a sensor outputting a signal indicating a vibration that is caused by a moving object; and a determination unit calculating an amount of change ΔP of a sensor output signal output from the sensor, comparing the calculated amount of change ΔP of the output sensor signal with a predetermined set range of the sensor output signal, and determining whether the moving object is in a stationary state or in a driving state.

According to the present disclosure, there is provided a new method which can detect a vibration of a moving object using a sensor, and thereby can more accurately determine a stationary state or a driving state of the moving object based on the detected vibration.

### BRIEF DESCRIPTION OF THE DRAWINGS

FIG. 1 illustrates a configuration of an apparatus for determining a driving state using a sensor according to an exemplary embodiment of the present disclosure;

FIG. 2 is a flowchart illustrating a method of determining a driving state using a sensor according to an exemplary embodiment of the present disclosure; and

FIG. 3 is a graph illustrating an output signal of an acceleration sensor depending on a driving state of a moving object.

### DETAILED DESCRIPTION OF EXEMPLARY EMBODIMENTS

Reference will now be made in detail to embodiments of the present disclosure, examples of which are illustrated in the accompanying drawings, wherein like reference numerals refer to the like elements throughout. The embodiments are described below in order to explain the present disclosure by referring to the figures.

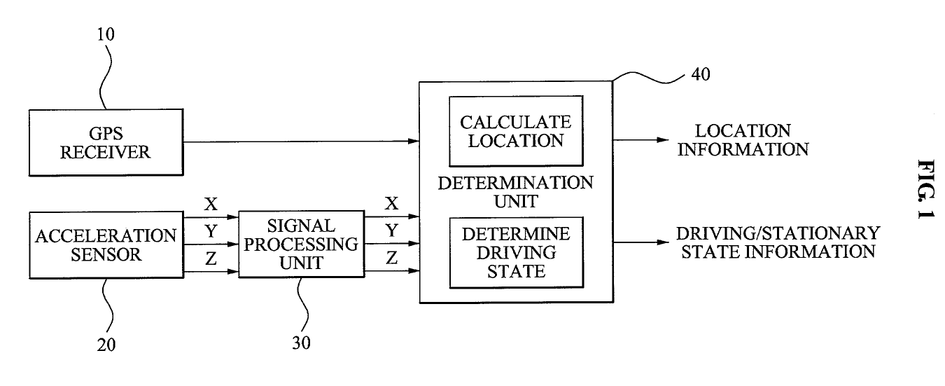

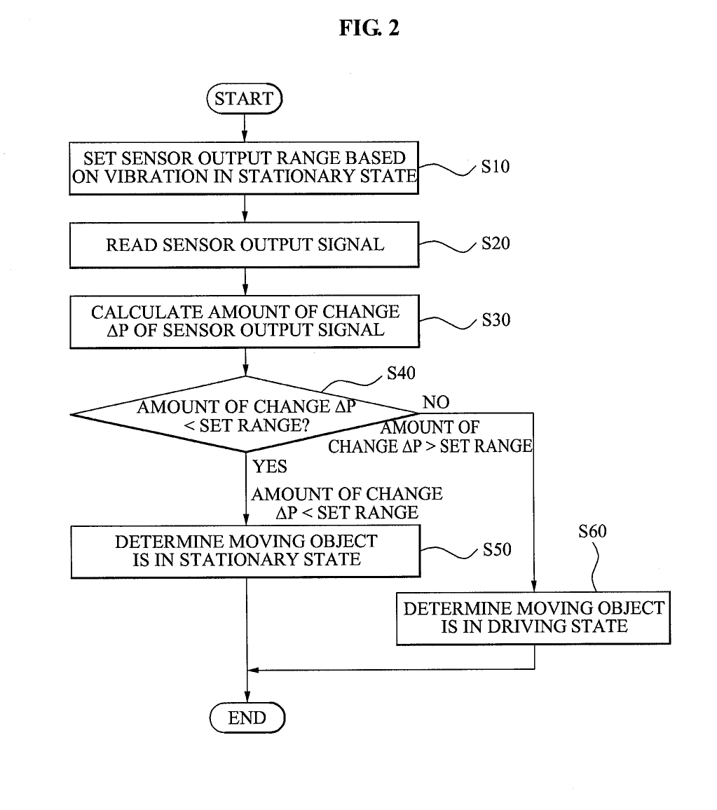

FIG. 1 illustrates a configuration of an apparatus for determining a driving state using a sensor according to an exemplary embodiment of the present disclosure, and FIG. 2 is a flowchart illustrating a method of determining a driving state using a sensor according to an exemplary embodiment of the present disclosure.

Referring to FIG. 1, a driving state determining apparatus will be described in detail.

The driving state determining apparatus is applied to a navigation device which includes a Global Positioning System (GPS) receiver 10. The GPS receiver 10 receives location signals from at least three GPS satellites and calculates a location of the navigation device based on the received location signals. The navigation device may be a type of a portable navigation device (PND).

The navigation device may include an acceleration sensor. In this instance, the navigation device may calculate a current location of a moving object from GPS signals received by the GPS receiver 10, and correct the calculated current location based on signals that are detected by the acceleration sensor, and the like.

The driving state determining apparatus according to the present disclosure detects an amount of vibration of the moving object and determines whether the moving object is in a stationary state or in a driving state based on the detected amount of vibration.

For the above operation, as shown in FIG. 1, the driving state determining apparatus includes a sensor to detect the vibration of the moving object, a signal processing unit 30 to process a signal of the sensor, and a determination unit 40 to determine whether the moving object is in the stationary state or in the driving state.

The sensor may include a separate sensing instrument to detect the vibration of the moving object. Also, the sensor may use the acceleration sensor, included in the navigation device, to detect the vibration of the moving object.

The acceleration sensor has characteristics of reacting to even a minor vibration of the moving object. Accordingly, the acceleration sensor (hereinafter, assigned with a reference numeral 20) may be used for the sensor to detect the vibration of the moving object.

In the present disclosure, the acceleration sensor 20 is constructed to output a sensor output signal of each axis with respect to the external vibration by using a three-axis acceleration sensor. The three-axis acceleration sensor includes X, Y, and Z axes. To detect the driving state of the moving object, it may be desirable to use all of the sensor output signals of the X, Y, and Z axes of the acceleration sensor 20.

Specifically, the acceleration sensor 20 may match one axis of the three axes with a driving direction of the moving object, match another axis with a left/right direction of the moving object, and match still another axis with an up/down direction of the moving object.

Also, the acceleration sensor 20 outputs an analog signal and thus the determination unit 40 may need to convert the analog signal into a recognizable digital signal. For the above operation, the signal processing unit 30 receives a sensor output signal of each axis of the acceleration sensor 20, converts the sensor output signal into a digital signal which is recognizable by the determination unit 40, and then transfers the converted sensor output signals to the determination unit 40.

The signal processing unit 30 may be an analog-to-digital (A/D) converter which converts an analog signal, which is an input signal, into a digital signal corresponding to a level of the analog signal.

The determination unit 40 may receive sensor output signals of the axes of the acceleration sensor 20, and determine whether the moving object is in the stationary state or in the driving state by using the received sensor output signals.

For the above operation, the determination unit 40 periodically receives a sensor output signal with respect to each of the axes of the acceleration sensor 20, and calculates an amount of change ΔP of the sensor output signal. Also, the determination unit 40 may determine whether the moving object is in the stationary state or in the driving state by using the amount of change ΔP of the sensor output signal corresponding to each of the X, Y, and Z axes of the acceleration sensor 20, that is, the amount of vibration of the moving object.

In this instance, the driving state of the moving object, which is determined by the determination unit 40, may be used as information when the navigation device calculates the current location of the moving object or when the navigation device guides a user along a path to a destination designated by the user.

Also, it is possible to implement all the control operations of the determination unit 40 using a control unit, without including a separate unit corresponding to the determination unit 40. The control unit includes a path guidance function and controls the overall operations of the navigation device.

Hereinafter, a method of determining, by the determination unit 40, a driving state of a moving object using the acceleration sensor 20 will be described in detail with reference to FIG. 2.

Referring to FIG. 2, in operation S10, a set range of a sensor output signal is pre-set with respect to each of the X, Y, and Z axes of the acceleration sensor 20. The set range is a reference to determine whether a moving object is in a stationary state or in a driving state.

Specifically, it is possible to pre-define a maximum vibration range which may occur due to various types of vibrations, such as a movement of an engine due to start-up, when the moving object is in a stationary state. The set range of the sensor output signal may be determined based on the range of a signal of each axis within the defined vibration range. The signal is output from the acceleration sensor 20.

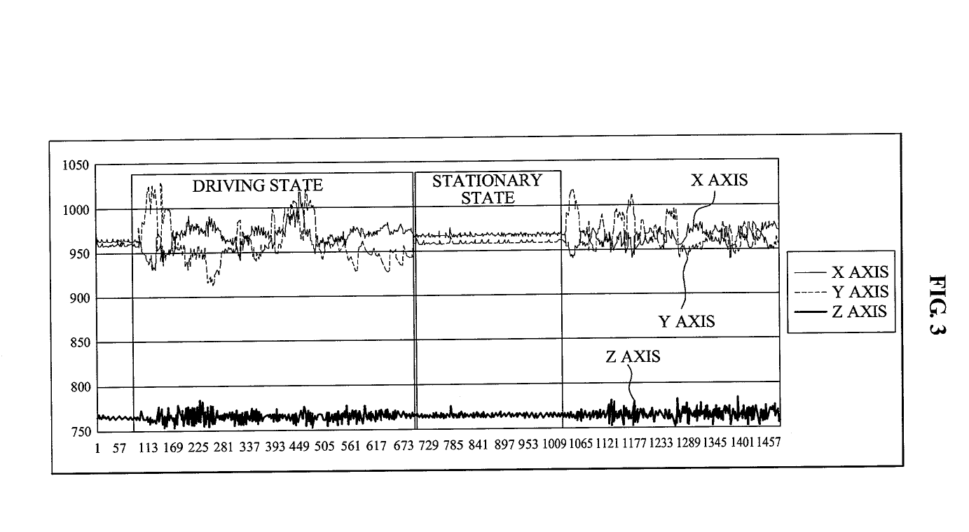

FIG. 3 is a graph illustrating an output signal of an acceleration sensor depending on a driving state of a moving object. As shown in FIG. 3, each axis of the acceleration sensor outputs a sensor signal of a predetermined level with respect to a vibration. When the moving object is in the driving state, an amount of change in a sensor output signal corresponding to each axis is very large. Conversely, when the moving object is in the stationary state, the amount of change in the sensor output signal corresponding to each axis is very small.

Accordingly, the set range of the sensor output signal may be set by using the characteristic of the acceleration sensor 20.

The vibration range of the moving object in the stationary state and the set range of the sensor output signal of each axis with respect to the vibration range may be set through various types of tests during a manufacturing process.

A standard of determining the driving state of the moving object uses the set range of the sensor output signal. This is to eliminate effects by the minor vibration, which may occur due to the start-up of the moving object in the stationary state, and thereby prevent the moving object from being misjudged to be in the driving state.

In operation S20, the determination unit 40 periodically reads a sensor output signal corresponding to each of the axes of the acceleration sensor 20 in an environment where the set range of the sensor output signal is set with respect to each of the axes of the acceleration sensor 20.

In operation S30, the determination unit 40 compares a level of a currently read output signal with a level of a previously read output signal among sensor output signals read with respect to each of the X, Y, and Z axes, and calculates an amount of change ΔP of a sensor output signal with respect to each of the X, Y, and Z axes of the acceleration sensor 20 based on the level difference value.

In operation S40, the determination unit 40 determines whether the calculated amount of change ΔP of the sensor output signal is within the set range with respect to each of the X, Y, and Z axes.

When the amount of change ΔP of the sensor output signal with respect to each of the X, Y, and Z axes is determined to be within the set range in operation S40, the determination unit 40 determines the moving object is in the stationary state in operation S50.

The set range with respect to the sensor output signal of each of the axes is determined by considering the maximum vibration range that may occur when the moving object is in the stationary state. Accordingly, even though vibration occurs in the stationary state, a sensor output signal does not exist outside the set range.

When the moving object is in the driving state, additional vibration may occur due to the movement of the engine and also due to a change in force applied to the moving object by acceleration/deceleration, force towards the gravity based on a condition of the road surface on which the moving object moves, force applied to the moving object by turning left or right. Accordingly, the amount of change of the sensor output signal corresponding to each of the axes of the acceleration sensor 20 is much greater than the set range. In this instance, the condition of the road surface includes paving materials, a curve, a slope, and the like.

In operation S60, when the amount of change ΔP of the sensor output signal with respect to each of the X, Y, and Z axes is outside the set range, the determination unit 40 determines the moving object is in the driving state.

As described above, according to the present disclosure, it is possible to calculate an amount of vibration of a moving object using an acceleration sensor of a navigation device and accurately determine a stationary state or a driving state of the moving object based on the calculated amount of vibration.

The exemplary embodiments of the present disclosure include computer-readable media including program instructions to implement various operations embodied by a computer. The media may also include, alone or in combination with the program instructions, data files, data structures, tables, and the like. The media and program instructions may be those specially designed and constructed for the purposes of the present disclosure, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

According to the present disclosure, there is provided a new method which can determine a driving state of a moving object based on an amount of vibration using a sensor capable of detecting the vibration of the moving object.

Also, a method of determining a stationary state or a driving state using a sensor according to the present disclosure does not require a process of setting an initial value. Accordingly, it is advantageous in that a process of setting an initial value is not needed

Particularly, without additionally including a vibration detection sensor, it is possible to determine a driving state of a moving object by using characteristics of an acceleration sensor included in a navigation device.

Also, according to the present disclosure, a set range is defined by considering a maximum vibration range that may occur in a stationary state of a moving object and a driving state of the moving object may be determined based on the set range. Accordingly, it is possible to solve the problem which may be a misjudgment of the driving state due to the minor vibration in the stationary state.

Also, a method and apparatus for determining a driving state using a sensor according to the present disclosure may provide more accurate determination results about a stationary state or a driving state of a moving object. Accordingly, it is possible to improve reliability of a navigation device.

Although a few embodiments of the present disclosure have been shown and described, the present disclosure is not limited to the described embodiments. Instead, it would be appreciated by those skilled in the art that changes may be made to these embodiments without departing from the principles and spirit of the present disclosure, the scope of which is defined by the claims and their equivalents.

1. A method of determining a driving state using a sensor, the method comprising:
calculating an amount of change ΔP in a sensor output signal of the sensor wherein the sensor detects a vibration of a moving object; and
comparing the calculated amount of change ΔP in the sensor output signal with a predetermined set range of the sensor output signal and determining whether the moving object is in a stationary state or in a driving state.

2. The method of claim 1, wherein the sensor uses a three-axis acceleration sensor including X, Y, and Z axes.

3. The method of claim 2, wherein the calculating of the amount of change comprises:
periodically reading a sensor output signal corresponding to each of the X, Y, and Z axes; and
calculating an amount of change ΔP in a sensor output signal with respect to each of the X, Y, and Z axes, based on a difference value between a current sensor output signal and a previous sensor output signal among sensor output signals read with respect to the respective X, Y, and Z axes.

4. The method of claim 2, wherein the predetermined set range of the sensor output signal defines a maximum vibration range that the moving object causes in the stationary state, and is determined with respect to each of the X, Y, and Z axes based on the range of a signal, output from a sensor of each of the axes, within the defined vibration range.

5. The method of claim 4, wherein the determining whether the moving object is in the stationary state or in the driving state comprises:
determining the moving object is in the stationary state when the amount of change ΔP of the sensor output signal is within the predetermined set range of a corresponding axis with respect to all of the X, Y, and Z axes of the sensor; and
determining the moving object is in the driving state when the amount of change ΔP of the sensor output signal is outside the predetermined range of the corresponding axis with respect to all of the X, Y, and Z axes of the sensor.

6. A computer-readable recording medium storing a program for implementing the method according to claim 1.

7. An apparatus for determining a driving state, the apparatus comprising:
a sensor outputting a signal indicating a vibration that is caused by a moving object; and
a determination unit calculating an amount of change ΔP of a sensor output signal output from the sensor, comparing the calculated amount of change ΔP of the output sensor signal with a predetermined set range of the sensor output signal, and determining whether the moving object is in a stationary state or in a driving state.

8. The apparatus of claim 7, wherein the sensor uses an acceleration sensor.

9. The apparatus of claim 8, wherein the acceleration sensor uses a three-axis acceleration sensor including X, Y, and Z axes, and outputs sensor signals of respective X, Y, and Z axes with respect to the vibration.

10. The apparatus of claim 9, wherein the acceleration sensor matches one axis of the three axes with a driving direction of the moving object, matches another axis with a left/right direction of the moving object, and matches still another axis with an up/down direction of the moving object.

11. The apparatus of claim 9, wherein the determination unit defines a set range of the sensor output signal with respect to each of the X, Y, and Z axes of the acceleration sensor, and determines whether the moving object is in the stationary state or in the driving state by using all of the sensor output signals of the three axes.

12. The apparatus of claim 7, further comprising:
a signal processing unit converting the sensor output signal into a signal, and outputting the converted sensor output signal to the determination unit, wherein the signal is recognizable by the determination unit.

13. The apparatus of claim 12, wherein the signal processing unit is an analog-to-digital (A/D) converter converting the sensor output signal into a digital signal which is in a range recognizable by the determination unit.
